(19) United States
(12) Patent Application Publication
(10) Pub. No.: US 2023/0173848 A1
(43) Pub. Date: Jun. 8, 2023

(54) PNEUMATIC TIRE

(71) Applicant: Sumitomo Rubber Industries, Ltd., Kobe-shi (JP)

(72) Inventor: Naoki IWAMOTO, Kobe-shi (JP)

(73) Assignee: Sumitomo Rubber Industries, Ltd., Kobe-shi (JP)

(21) Appl. No.: 17/979,361

(22) Filed: Nov. 2, 2022

(30) Foreign Application Priority Data
Dec. 7, 2021 (JP) 2021-198783

(51) Int. Cl. B60C 11/00; B60C 19/00

(52) U.S. Cl. CPC B60C 11/0008; B60C 11/005; B60C 19/002; B60C 2011/0025

(57) ABSTRACT

A pneumatic tire includes a tread portion having a tread rubber and a tire inner cavity surface, and a noise damper made of a porous material fixed to the tire inner cavity surface. The tread rubber includes an outer tread rubber having a ground-contacting surface, and an inner tread rubber disposed inwardly in the tire radial direction of the outer tread rubber and outwardly in the tire radial direction of the noise damper. A loss tangent tan δ of the inner tread rubber at 30° C. is smaller than a loss tangent tan δ of the outer tread rubber at 30° C.

### RELATED APPLICATIONS

This application claims the benefit of foreign priority to Japanese Patent Application No. JP2021-198783, filed Dec. 7, 2021, which is incorporated by reference in its entirety.

### FIELD OF THE DISCLOSURE

The present disclosure relates to a pneumatic tire.

### BACKGROUND OF THE DISCLOSURE

The following Patent Document 1 discloses a pneumatic tire. The pneumatic tire includes a circumferentially extending band-shaped noise damper that is made of sponge material. The noise damper is fixed to the inner surface of the tread portion in the tire radial direction.

### PATENT DOCUMENT

### Patent Document 1

Japanese Unexamined Patent Application Publication 2012-86600

### SUMMARY OF THE DISCLOSURE

The noise damper can convert the vibration energy of the air in the tire cavity into heat energy to reduce tire noise such as resonance noise. Thus, the tread rubber to which the noise damper is fixed easily stores heat during running. As the heat storage property of the tread rubber is increased, there is a problem that the durability of the tread portion may deteriorate.

The present disclosure has been made in view of the above circumstances and has a major object to provide a pneumatic tire capable of improving noise performance and durability.

In one aspect of the present disclosure, a pneumatic tire includes a tread portion having a tread rubber and a tire inner cavity surface, and a noise damper made of a porous material fixed to the tire inner cavity surface. The tread rubber includes an outer tread rubber having a ground-contacting surface, and an inner tread rubber disposed inwardly in the tire radial direction of the outer tread rubber and outwardly in the tire radial direction of the noise damper. A loss tangent tan δ of the inner tread rubber at 30° C. is smaller than a loss tangent tan δ of the outer tread rubber at 30° C.

### BRIEF DESCRIPTION OF THE DRAWINGS

FIG. 1 is a tire meridian cross-sectional view showing an embodiment of a pneumatic tire; and

FIG. 2 is a partial enlarged view of a tread portion with a noise damper of FIG. 1.

### DETAILED DESCRIPTION OF THE DISCLOSURE

Hereinafter, one or more embodiments of the present disclosure will be described with reference to the drawings.

Note that the drawings may contain exaggerated representations that differ from the actual structural dimensional ratios to aid in understanding the content of the disclosure. Further, throughout the embodiments, the same or common elements are denoted by the same reference numerals, and duplicate description may be omitted. Furthermore, the specific configurations shown in the embodiments and drawings are for understanding the contents of the present disclosure, and the present disclosure is not limited to the specific configurations shown.

### Pneumatic Tire (The First Embodiment)

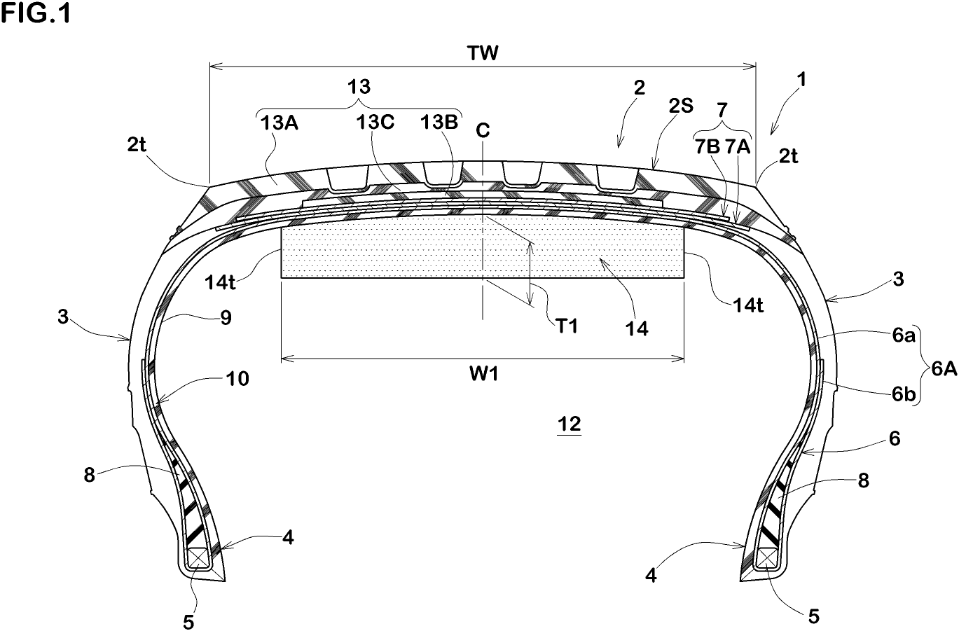

FIG. 1 is a tire meridian cross-sectional view showing an embodiment of a pneumatic tire (hereinafter, simply referred to as “tire”) 1. The tire 1 according to the present embodiment is exemplified as a pneumatic tire for passenger car, for example. However, the tire 1 is not limited to such an aspect, and may be a pneumatic tire for heavy load and the like, for example.

As illustrated in FIG. 1, the tire 1 includes a tread portion 2. Further, the tire 1 according to the present embodiment includes a carcass 6 and a belt layer 7.

### Carcass

In the present embodiment, the carcass 6 extending between a pair of bead portions 4. In the present embodiment, the carcass 6 includes at least one carcass ply. In this embodiment, the carcass 6 is composed of a single carcass ply 6A.

In the present embodiment, the carcass ply 6A includes a main portion 6a extending between bead cores 5 each disposed in a respective one of the bead portions 4, through the tread portion 2 and a pair of sidewall portions 3, and a pair of turned-up portions 6b connected to the main portion 6a and each turned up around the bead core 5 from axially inside to outside of the tire. In each bead portion 4, a bead apex rubber 8 which extends from the bead core 5 is disposed between the main portion 6a and the turn-up portion 6b.

In the present embodiment, the carcass ply 6A, for example, includes a plurality of carcass cords (not illustrated) oriented at an angle of from 80 to 90 degrees with respect to the tire equator C. As the carcass cords, organic fiber cords such as aromatic polyamides and rayon may be used, for example.

In the present embodiment, an inner liner rubber 10 which forms a tire inner cavity surface 9 is arranged inside the carcass 6. The inner liner rubber 10 is composed of air-impermeable rubber such as butyl rubber so that the filled air of the tire 1 can be kept airtight.

### Belt Layer

In the present embodiment, the belt layer 7 is disposed outwardly in the tire radial direction of the carcass 6 in the tread portion 2. In the present embodiment, the belt layer 7 is composed of two belt plies consisting of a radially inner belt ply 7A and a radially outer belt ply 7B.

In the present embodiment, each of the belt plies 7A and 7B has a plurality of belt cords (not illustrated) which, for example, is oriented at an angle of from 10 to 35 degrees with respect to the tire circumferential direction. These belt piles 7A and 7B are superimposed such that the belt cords of the belt ply 7A and the belt cords of the belt ply 7A cross with each other. As the belt cords, for example, steel, aramid, rayon, etc. may be preferably adopted.

### Tread Portion

In the present embodiment, the tread portion 2 has a pair of tread edges 2t. The pair of tread edges 2t is the axial outermost edges of the tread ground-contacting surface 2S of the tire 1 which occurs under the condition such that the tire 1 under a normal state is grounded on a plane with a standard tire load at zero camber angles. In the normal state, the distance between the tread edges 2t and 2t in the tire axial direction is defined as the tread ground-contacting width TW.

As used herein, the “normal state” is such that the tire 1 is mounted onto a standard wheel rim with a standard pressure but loaded with no tire load. As used herein, unless otherwise noted, dimensions of portions of the tire are values measured under the normal state. In addition, the dimensions of each portion of the tire shall allow the normal error contained in a rubber molded product.

As used herein, the “standard wheel rim” is a wheel rim officially approved for each tire by standards organizations on which the tire 1 is based. For example, the standard wheel rim is the “standard rim” specified in JATMA, the “Design Rim” in TRA, and the “Measuring Rim” in ETRTO.

As used herein, the “standard pressure” is a standard pressure officially approved for each tire by standards organizations on which the tire 1 is based. For example, the standard pressure is the “maximum air pressure” in JATMA, the maximum pressure given in the “Tire Load Limits at Various Cold Inflation Pressures” table in TRA, and the “Inflation Pressure” in ETRTO.

As used herein, the “standard tire load” is a tire load officially approved for each tire by the standards organization in which the tire 1 is based. For example, the standard tire load is the “maximum load capacity” in JATMA, the maximum value given in the above-mentioned table in TRA, and the “Load Capacity” in ETRTO, for example.

In the present embodiment, the tire 1 includes a tread rubber 13 and a noise damper 14.

### Noise Damper

In the present embodiment, the noise damper 14 is fixed to a tire inner cavity surface 9 of the tread portion 2. In the present embodiment, the noise damper 14 is formed in a band shape with a bottom surface fixed to the tire inner cavity surface 9 and extends in the tire circumferential direction. Further, the noise damper 14 includes a pair of outermost ends (not illustrated) on both sides in the tire circumferential direction, which is butt-jointed with each other to form a substantially annular shape. The pair of outermost ends may be separated in the tire circumferential direction.

In the present embodiment, the noise damper 14 has substantially the same cross-sectional shape at each position in the tire circumferential direction except for the pair of outer ends (not illustrated) in the tire circumferential direction. However, the noise damper is not limited to such an aspect. In addition, the cross-sectional shape of the noise damper 14 can be set as appropriate. In the present embodiment, the noise damper 14 has a flat horizontal shape (in this embodiment, a horizontally long rectangular shape) in which a thickness in the tire radial direction (the maximum thickness T1) is smaller than a width in the tire axial direction (the maximum width W1). As a result, the noise damper 14 can be prevented from collapsing or deforming during tire running.

In the present embodiment, the noise damper 14 is made of a porous material. As the porous material, a porous sponge material may be exemplified. The sponge material has a spongy porous structure. In addition, the sponge material includes, for example, the so-called sponge itself obtained by foaming rubber or synthetic resin, as well as those in which animal fibers, plant fibers, synthetic fibers, etc. are entwined and integrally connected.

As the sponge material, synthetic resin sponges such as ether-based polyurethane sponges, ester-based polyurethane sponges, and polyethylene sponges, and chloroprene rubber sponges (CR sponges) may be adopted. Other examples of sponge materials may include ethylene propylene rubber sponge (EDPM sponge) and nitrile rubber sponge (NBR sponge). In particular, polyurethane-based or polyethylene-based sponges including ether-based polyurethane sponges are preferable from the viewpoints of sound control (noise performance), light weight, controllability of foaming, and durability.

The porous material (sponge material in this example) is easily deformed by shrinkage or bending. Thus, the noise damper 14 can deform flexibly following the deformation of the inner liner rubber 10 during running.

The noise damper 14 made of such a porous material can convert the air vibration in the tire cavity 12 into heat energy to reduce it by its surface and internal holes (cells). This can reduce the noise inside the vehicle due to the resonance of the air. Further, the noise damper 14 can alleviate the impact received from the tread portion 2 while running, and the road noise can be reduced. Thus, in the present embodiment, the tire 1 can improve noise performance.

The noise damper 14 generates heat during running because it converts the air vibration in the tire cavity 12 into heat energy to exert a sound control effect. When the heat of the noise damper 14, for example, is propagated to the tread edge 2t sides of the tread rubber 13, which tend to generate a large amount of heat during running, the heat storage amount of the tread rubber 13 on the tread edge 2t sides may increase and be difficult to improve durability. Thus, it is preferable that outer ends 14t of the noise damper 14 in the tire axial direction are arranged inside the tire axial direction rather than the tread edges 2t. As a result, the tire 1 according to the present embodiment can suppress the increase in the amount of heat storage on the tread edge 2t sides of the tread rubber 13, and the durability can be improved.

Preferably, a maximum width W1 in the tire axial direction of the noise damper 14 is in a range from 70% to 95% of the tread ground-contacting width TW. By setting the maximum width W1 of the noise damper equal to or less than 95% of the tread ground-contacting width TW, the heat of the noise damper 14 can be suppressed from being propagated to the tread edge 2t sides of the tread rubber 13, and the durability can be improved. By setting the maximum width W1 of the noise damper 14 equal to or more than 70% of the tread ground-contacting width TW, air vibration in the tire cavity 12 can be absorbed effectively and the noise performance can be improved. From this point of view, the maximum width W1 of the noise damper 14 is more preferably equal to or less than 90% of the tread ground-contacting width TW, also preferably equal to or more than 75%.

Preferably, the maximum thickness T1 of the noise damper 14 in the tire radial direction is equal to or less than 70 mm. As a result, it is possible to suppress the increase in heat generation of the noise damper 14, and the durability can be improved. Preferably, the maximum thickness T1 is equal to or more than 40 mm. As a result, the noise damper 14 can efficiently absorb the air vibration in the tire cavity 12, and the noise performance can be improved. From this point of view, the maximum thickness T1 is preferably 60 mm or less, and preferably 50 mm or more.

### Tread Rubber

In the present embodiment, the tread rubber 13 is disposed in the tread portion 2. In the present embodiment, the tread rubber 13 is disposed outwardly in the tire radial direction of the belt layer 7.

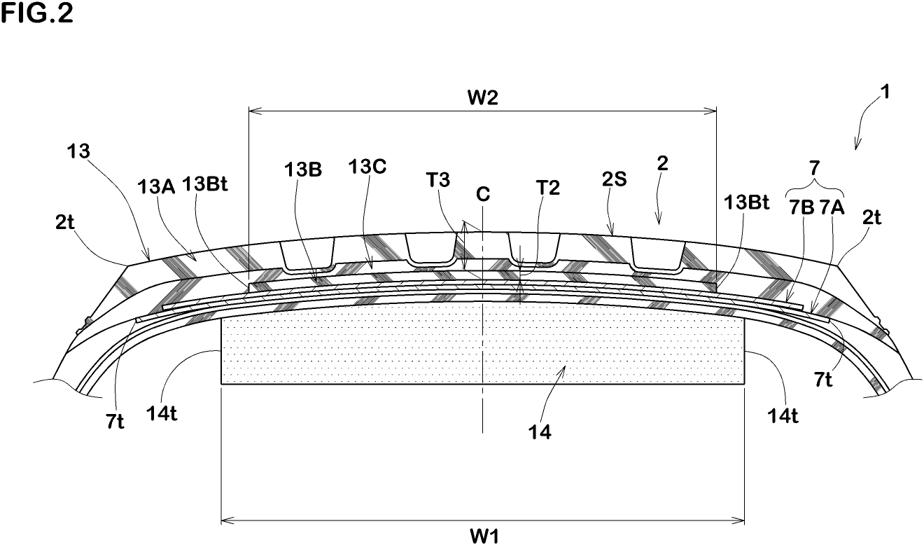

In the present embodiment, the tread rubber 13 includes an outer tread rubber 13A and an inner tread rubber 13B. Further, in the present embodiment, the tread rubber 13 includes a middle tread rubber 13C. FIG. 2 is a partial enlarged view of the tread portion 2 with a noise damper 14 of FIG. 1.

In the present embodiment, the outer tread rubber 13A constitutes the tread ground-contacting surface 2S. In the present embodiment, the outer tread rubber 13A extends outwardly in the tire axial direction beyond both outer ends 7t of the belt layer 7 in the tire axial direction.

The inner tread rubber 13B is disposed inwardly in the tire radial direction of the outer tread rubber 13A and is disposed outwardly in the tire radial direction of the noise damper 14. In the present embodiment, the inner tread rubber 13B is arranged adjacent to the belt layer 7.

The middle tread rubber 13C is disposed between the outer tread rubber 13A and the inner tread rubber 13B. In the present embodiment, the middle tread rubber 13C extends in the tire axial direction beyond the outer ends 13Bt in the tire axial direction of the inner tread rubber 13B as well as the outer ends 7t in the tire axial direction of the belt layer 7.

Rubber compositions of the outer tread rubber 13A, the inner tread rubber 13B and the middle tread rubber 13C are not particularly limited. The rubber compositions include a rubber base material, a reinforcing agent (filler), a cross-linking agent, and a vulcanization accelerator. As the rubber base material, for example, diene-based rubbers such as natural rubber, butadiene rubber, isoprene rubber, and styrene-butadiene rubber, and a mixture thereof can be adopted. As the reinforcing agent (filler), for example, carbon, silica, or the like can be adopted. As the cross-linking agent, for example, sulfur can be adopted. As the vulcanization accelerator, for example, thiazole-based, guanidine-based, sulfenamide-based, thiuram-based, etc. can be adopted.

As mentioned above, the noise damper 14 generates heat while running. Thus, the tread rubber 13 to which the noise damper 14 is fixed easily stores heat by transmitting heat from the noise damper 14. When the heat storage property of the tread rubber 13 becomes large, the durability of the tread portion 2 tends to deteriorate.

In the present embodiment, a loss tangent tan δ of the inner tread rubber 13B at 30° C. is set smaller than a loss tangent tan δ of the outer tread rubber 13A at 30° C. The loss tangent tan δ at 30° C. can be set, for example, by adjusting the amount of the above-mentioned reinforcing agent or cross-linking agent added, and the type and amount of vulcanization accelerator added.

In this specification, a loss tangent tan δ at 30° C. is a value measured using a viscoelastic spectrometer manufactured by Iwamoto Seisakusho Co., Ltd. under the following conditions in accordance with the provisions of JIS-K6394.
Initial distortion: 10%
Amplitude: plus/minus 2%
Frequency: 10 Hz
Deformation mode: Tension
Measurement temperature: 30° C.

In the present embodiment, since a loss tangent tan δ at 30° C. of the inner tread rubber 13B is set smaller than a loss tangent tan δ at 30° C. of the outer tread rubber 13A, the heat generation of the inner tread rubber 13B at the start of running can be suppressed compared to the outer tread rubber 13A. Thus, by arranging the inner tread rubber 13B made of such a low heat generation rubber outward in the tire radial direction of the noise damper 14, the heat stored in the tread rubber 13 can be suppressed by receiving the heat from the noise damper 14, which generates heat while running. As a result, in the present embodiment, the tire 1 can suppress the increase in heat storage property of the tread rubber 13, and the durability of the tread portion 2 can be improved. Thus, in the present embodiment, the tire 1 can improve the noise performance and durability.

In order to further improve the above-mentioned effect, the loss tangent tan δ of the inner tread rubber 13B at 30° C. is preferably equal to or less than 0.15. By setting the loss tangent tan δ of the inner tread rubber 13B at 30° C. being equal to or less than 0.15, the inner tread rubber 13B can further suppress heat generation while running. This can reduce the heat storage of the tread rubber 13 and improve the durability of the tread portion 2. From this point of view, the loss tangent tan δ of the inner tread rubber 13B at 30° C. is preferably equal to or less than 0.13.

Further, the loss tangent tan δ of the inner tread rubber 13B at 30° C. is preferably equal to or more than 0.10, for example. As a result, the deformation of the inner tread rubber 13B during running can be suppressed from becoming smaller than necessary, and steering stability can be maintained.

On the other hand, if the loss tangent tan δ of the outer tread rubber 13A at 30° C. is larger than the loss tangent tan δ of the inner tread rubber at 30° C., the value can be set appropriately. In the present embodiment, the loss tangent tan δ of the outer tread rubber 13A at 30° C. can be set to, for example, 0.13 to 0.30 from the viewpoint of improving steering stability.

Preferably, a pair of outer ends 13Bt in the tire axial direction of the inner tread rubber 13B is located inwardly in the tire axial direction of the tread edges 2t of the tread portion 2. As a result, it is possible to suppress the placement of the inner tread rubber 13B, which has a relatively small deformation (loss tangent tan δ), on the tread edges 2t side where the ground pressure is relatively large during cornering. Thus, the tire has a larger grip when cornering and the steering stability can be maintained.

Further, the pair of outer ends 13Bt of the inner tread rubber 13B is preferably located inwardly in the tire axial direction of the pair of outer ends 14t in the tire axial direction of the noise damper 14. As a result, the tire axial region of the inner tread rubber 13B with respect to the noise damper 14 may be suppressed from becoming larger than necessary, and the steering stability can be maintained.

Preferably, the maximum width W2 in the tire axial direction of the inner tread rubber 13B is in a range from 70% to 90% of the maximum width W1 in the tire axial direction of the noise damper 14. By setting the maximum width W2 of the inner tread rubber 13B to 90% or less of the maximum width W1 of the noise damper 14, the inner tread rubber 13B does not become larger than necessary and the steering stability can be maintained. Further, by setting the maximum width W2 of the inner tread rubber 13B to 70% or more of the maximum width W1 of the noise damper 14, it can be suppressed that the heat storage property of the tread rubber 13 increases, and the durability of tread portion 2 can be improved. From this point of view, the maximum width W2 of the inner tread rubber 13B is preferably equal to or less than 85% of the maximum width W1 of the noise damper 14, and preferably equal to or more than 75%.

Preferably, the maximum thickness T2 (the maximum thickness in the tire radial direction) of the inner tread rubber 13B is equal to or less than 20% of the maximum thickness T3 (the maximum thickness in the tire radial direction) of the tread rubber 13. As a result, the ratio of the inner tread rubber 13B in the tread rubber 13 can be suppressed from becoming more than necessary, and the steering stability can be maintained. Further, the maximum thickness T2 of the inner tread rubber 13B is preferably equal to or more than 8% of the maximum thickness T3 of the tread rubber 13. This can suppress the increase in heat storage of the tread rubber 13 and improve the durability of the tread portion 2. From this point of view, the maximum thickness T2 of the inner tread rubber 13B is preferably equal to or less than 15% and preferably equal to or more than 10% of the maximum thickness T3 of the tread rubber 13.

In the present embodiment, a loss tangent tan δ of the inner tread rubber 13B at 30° C. is set smaller than a loss tangent tan δ of the middle tread rubber 13C at 30° C. As a result, the inner tread rubber 13B can suppress heat generation from the start of running compared to the middle tread rubber 13C. Thus, the inner tread rubber 13B can suppress the heat storage of the tread rubber 13 due to the heat generated from the noise damper 14 during running, and the durability of the tire can be improved.

Preferably, a loss tangent tan δ of the middle tread rubber 13C at 30° C. is set larger than a loss tangent tan δ of the outer tread rubber 13A at 30° C. As a result, in the outer tread rubber 13A, the inner tread rubber 13B and the middle tread rubber 13C which constitute the tread rubber 13, the loss tangent tan δ of the middle tread rubber 13C at 30° C. is set to be the largest. Thus, the heat generation in the outer tread rubber 13A can be suppressed. With this, heat transfer from the noise damper 14 to the tread rubber 13 can be suppressed, and the durability of the tread portion 2 can be improved. In order to effectively exert such an effect, the loss tangent tan δ of the middle tread rubber 13C at 30° C. is set to, for example, 0.20 to 0.40.

### Pneumatic Tire (second Embodiment)

The tread rubber 13 in accordance with the previous embodiment is provided with the middle tread rubber 13C between the outer tread rubber 13A and the inner tread rubber 13B, but is not limited to such an embodiment. For example, the middle tread rubber 13C may be omitted. In such a tire 1, similar to the tire 1 of the previous embodiment, a loss tangent tan δ of the inner tread rubber 13B at 30° C. is set smaller than a loss tangent tan δ of the outer tread rubber 13A at 30° C. This can suppress the increase in heat storage of the tread rubber 13 and improve the durability of the tread portion 2.

Although the particularly preferred embodiments of the present disclosure have been described in detail above, the present disclosure is not limited to the illustrated embodiments, and can be modified into various embodiments.

### EXAMPLE

### Example A

Pneumatic tires shown in FIG. 1 were prepared based on the specifications in Table 1 (Examples 1 to 8). For comparison, a pneumatic tire with the same loss tangent tan δ at 30° C. of the inner tread rubber and the loss tangent tan δ at 30° C. of the outer tread rubber was also prepared (comparative example).

Then, durability, noise performance and steering stability performance were evaluated for each test tire. The specifications of each tire are the same except for the configurations shown in Table 1, and the tire sizes, etc. are as follows. Further, the test methods are as follows. The test results are shown in Table 1.
Tire size: 225/65R17 102H
Rim size: 17x5.5J
Internal pressure: 230 kPa
Vehicle: Passenger car with 2000 cc displacement
Tread ground-contacting width TW: 180 mm
Maximum thickness of tread rubber T3: 11.5 mm
Inner tread rubber:
   Maximum width W2 / maximum width W1 of noise damper: 90%
   Maximum thickness T2 / maximum tread rubber thickness T3: 10%
   Position of outer ends in tire axial direction: inside in tire axial direction than tread edges
Outer tread rubber:
   Loss tangent tan δ at 30° C.: 0.20
Middle tread rubber:
   Loss tangent tan δ at 30° C.: 0.30

Durability (high-speed durability) test:
In a drum running tester, each test tire filled with the above internal pressure was run with a load of 6.67 kN, and the speed is increased by 10 km/h every 10 minutes from 80 km/h. Then, the running time until the tire was damaged was measured. The evaluation is shown by an index with the running time of Example 1 as 100. The larger the value, the higher the durability (high-speed durability). The evaluation 80 or more indicates better durability.

Noise performance test:
The noise (vehicle exterior noise) when the above-mentioned vehicle equipped with each test tire set under the above conditions was run on a test course on a dry road (running speed: 30 km/h) was evaluated by the driver’s sensory. The evaluation is shown by a score with Example 1 as 100. The larger the value, the better. The evaluation 80 or more indicates better noise performance.

Steering stability test:
The above-mentioned vehicle equipped with each test tire set under the above conditions was run on a test course on a dry road (running speed: 40 to 80 km / h). Then, the steering stability (responsiveness, rigidity, grip force, stability, and transient characteristics) at that time was evaluated by the sensuality of the test driver. The evaluation is shown by a score with Example 1 as 100, and the larger the value, the better. The evaluation 80 or higher indicates that the vehicle has the required performance.

TABLE 1

| | Comparative example | Ex. 1 | Ex. 2 | Ex. 3 | Ex. 4 | Ex. 5 | Ex. 6 | Ex. 7 | Ex. 8 |
|---|---|---|---|---|---|---|---|---|---|
| Loss tangent tan 8 of inner tread rubber at 30° C. | 0.30 | 0.15 | 0.13 | 0.15 | 0.15 | 0.15 | 0.15 | 0.15 | 0.15 |
| Maximum width W1 of noise damper / tread ground-contacting width TW (%) | 80 | 80 | 80 | 50 | 70 | 95 | 110 | 80 | 80 |
| Maximum thickness T1 of noise damper (mm) | 50 | 50 | 50 | 50 | 50 | 50 | 50 | 70 | 80 |
| Durability (index) | 70 | 100 | 105 | 105 | 102 | 90 | 80 | 90 | 80 |
| Noise performance (index) | 100 | 100 | 100 | 80 | 95 | 103 | 110 | 103 | 105 |
| Steering stability (index) | 105 | 100 | 98 | 100 | 100 | 100 | 100 | 100 | 100 |
| Comprehensive evaluation of durability and noise performance (index) | 170 | 200 | 205 | 185 | 197 | 193 | 190 | 193 | 185 |

As a result of the test, it was confirmed that Examples 1 to 8 were able to improve the noise performance and the durability (improve the overall evaluation) compared to the comparative example. Furthermore, some Examples which have a better loss tangent tan δ of the inner tread rubber, a better ratio of the maximum width W1 of the noise damper to the tread ground width TW, and a better maximum thickness T1 of the noise damper could improve noise performance, durability, and steering stability in a well-balanced manner as compared to the others.

### Example B

Pneumatic tires shown in FIG. 1 were prepared based on the specifications in Table 2 (Example 9 to Example 14). Then, durability, noise performance and steering stability performance were evaluated for each test tire. The specifications of each tire are the same except for the configuration shown in Table 2, and the tire size etc. are the same as in Example A except for the following. The test method is the same as in Example A. The test results are shown in Table 2.

Noise damper:
Maximum width W1 / tread ground-contacting width TW: 80%
Maximum thickness T1: 50 mm

Inner tread rubber:
Loss tangent tan δ at 30° C.: 0.15

Outer tread rubber:
Loss tangent tan δ at 30° C.: 0.20

Middle tread rubber:
Loss tangent tan δ at 30° C.: 0.30

TABLE 2

| | Ex. 9 | Ex. 10 | Ex. 1 | Ex. 11 | Ex. 12 | Ex. 13 | Ex. 14 |
|---|---|---|---|---|---|---|---|
| Maximum width W2 of inner tread rubber / maximum width W1 of noise damper (%) | 50 | 70 | 90 | 100 | 90 | 90 | 90 |
| Location of outer ends of inner tread rubber (A: inside of tread edges, B: the same as tread edges) | A | A | A | A | B | A | A |
| Maximum thickness T2 of inner tread rubber / maximum thickness T3 of tread rubber (%) | 10 | 10 | 10 | 10 | 10 | 20 | 30 |
| Durability (index) | 80 | 95 | 100 | 105 | 100 | 102 | 105 |
| Noise performance (index) | 100 | 100 | 100 | 100 | 100 | 100 | 100 |
| Steering stability (index) | 110 | 105 | 100 | 80 | 80 | 95 | 80 |
| Comprehensive evaluation of durability and noise performance (index) | 180 | 195 | 200 | 205 | 200 | 202 | 205 |

The test results show that the Examples 9 to 14 can improve the noise performance and durability (better overall rating) compared to the comparative examples in Table 1. Furthermore, some examples which have, for the inner tread rubber, a better ratio between the maximum width W2 and the maximum width W1 of the noise damper, a better location of the outer edge, and a better ratio between the maximum thickness T2 and the maximum thickness T3 of the tread rubber have better balanced noise performance and durability than the other examples, and steering stability was also improved.

### Additional Notes

The present disclosure includes the following aspects.

### Note 1

A pneumatic tire comprising:
a tread portion having a tread rubber and a tire inner cavity surface; and
a noise damper made of a porous material fixed to the tire inner cavity surface, wherein
the tread rubber comprises an outer tread rubber having a ground-contacting surface, and an inner tread rubber disposed inwardly in a tire radial direction of the outer tread rubber and outwardly in the tire radial direction of the noise damper, and
a loss tangent tan δ of the inner tread rubber at 30° C. is smaller than a loss tangent tan δ of the outer tread rubber at 30° C.

### Note 2

The pneumatic tire according to note 1, wherein
a pair of ends in a tire axial direction of the inner tread rubber is arranged inwardly in the tire axial direction of a pair of outer ends in the tire axial direction of the noise damper.

### Note 3

The pneumatic tire according to note 2, wherein
a maximum width in the tire axial direction of the inner tread rubber is in a range from 70% to 90% of a maximum width in the tire axial direction of the noise damper.

### Note 4

The pneumatic tire according to any one of notes 1 to 3, wherein
a pair of ends in a tire axial direction of the inner tread rubber is arranged inwardly in the tire axial direction of a pair of tread edges of the tread portion.

### Note 5

The pneumatic tire according to any one of notes 1 to 4, wherein
the inner tread rubber has a maximum thickness equal to or less than 20% of a maximum thickness of the tread rubber.

### Note 6

The pneumatic tire according to any one of notes 1 to 5, wherein
a loss tangent tan δ of the inner tread rubber at 30° C. is equal to or less than 0.15.

### Note 7

The pneumatic tire according to any one of notes 1 to 6,
the tread rubber further comprising a middle tread rubber between the outer tread rubber and the inner tread rubber, wherein
the middle tread rubber has a loss tangent tan δ at 30° C. greater than the loss tangent tan δ of the outer tread rubber at 30° C.

### Note 8

The pneumatic tire according to any one of notes 1 to 7, wherein
the noise damper has a maximum width in a tire axial direction in a range from 70% to 95% of a tread ground-contacting width.

### Note 9

The pneumatic tire according to any one of notes 1 to 8, wherein
the noise damper has a maximum thickness equal to or less than 70 mm.

1. A pneumatic tire comprising:
a tread portion having a tread rubber and a tire inner cavity surface; and
a noise damper made of a porous material fixed to the tire inner cavity surface, wherein
the tread rubber comprises an outer tread rubber having a ground-contacting surface, and an inner tread rubber disposed inwardly in a tire radial direction of the outer tread rubber and outwardly in the tire radial direction of the noise damper, and
a loss tangent tan δ of the inner tread rubber at 30° C. is smaller than a loss tangent tan δ of the outer tread rubber at 30° C.

2. The pneumatic tire according to claim 1, wherein
a pair of ends in a tire axial direction of the inner tread rubber is arranged inwardly in the tire axial direction of a pair of outer ends in the tire axial direction of the noise damper.

3. The pneumatic tire according to claim 2, wherein
a maximum width in the tire axial direction of the inner tread rubber is in a range from 70% to 90% of a maximum width in the tire axial direction of the noise damper.

4. The pneumatic tire according to claim 1, wherein
a pair of ends in a tire axial direction of the inner tread rubber is arranged inwardly in the tire axial direction of a pair of tread edges of the tread portion.

5. The pneumatic tire according to claim 1, wherein
the inner tread rubber has a maximum thickness equal to or less than 20% of a maximum thickness of the tread rubber.

6. The pneumatic tire according to claim 1, wherein
a loss tangent tan δ of the inner tread rubber at 30° C. is equal to or less than 0.15.

7. The pneumatic tire according to claim 1,
the tread rubber further comprising a middle tread rubber between the outer tread rubber and the inner tread rubber, wherein
the middle tread rubber has a loss tangent tan δ at 30° C. greater than the loss tangent tan δ of the outer tread rubber at 30° C.

8. The pneumatic tire according to claim 1, wherein
the noise damper has a maximum width in a tire axial direction in a range from 70% to 95% of a tread ground-contacting width.

9. The pneumatic tire according to claim 1, wherein the noise damper has a maximum thickness equal to or less than 70 mm.

10. The pneumatic tire according to claim 1, wherein
the outer tread rubber has a loss tangent tan δ at 30° C. in a range from 0.13 to 0.30.

11. The pneumatic tire according to claim 10, wherein
the loss tangent tan δ of the inner tread rubber at 30° C. is in a range from 0.10 to 0.15.

12. The pneumatic tire according to claim 10,
the tread rubber further comprising a middle tread rubber between the outer tread rubber and the inner tread rubber, wherein
the middle tread rubber has a loss tangent tan δ at 30° C. greater than the loss tangent tan δ of the outer tread rubber at 30° C.

13. The pneumatic tire according to claim 12, wherein
the middle tread rubber extends in the tire axial direction beyond a pair of outer ends in the tire axial direction of the inner tread rubber.

14. The pneumatic tire according to claim 12, wherein
the loss tangent tan δ of the middle tread rubber at 30° C. is in a range from 0.20 to 0.40.

15. The pneumatic tire according to claim 13, wherein
the loss tangent tan δ of the middle tread rubber at 30° C. is in a range from 0.20 to 0.40.

16. The pneumatic tire according to claim 15, wherein
a maximum width in the tire axial direction of the inner tread rubber is in a range from 70% to 90% of a maximum width in the tire axial direction of the noise damper.
